(19) United States
(12) Patent Application Publication
(10) Pub. No.: US 2015/0175906 A1
(43) Pub. Date: Jun. 25, 2015

(54) METHOD FOR OPTIMISING THE PRODUCTION OF DISTILLATES COMPRISING A CATALYTIC CRACKING STEP

(71) Applicants: TOTAL RAFFINAGE FRANCE, Courbevoie (FR); AXENS, Rueil Malmaison (FR)

(72) Inventors: Marc Bories, Saint Jouin de Bruneval (FR); Michael Echard, Montivilliers (FR); Romain Roux, Rueil-Malmaison (FR)

(73) Assignees: AXENS, Rueil Malmaison (FR); TOTAL RAFFINAGE FRANCE, Courbevoie (FR)

(21) Appl. No.: 14/358,109

(22) PCT Filed: Dec. 12, 2012
(86) PCT No.: PCT/FR2012/052898

§ 371 Date: May 14, 2014

(30) Foreign Application Priority Data
Dec. 23, 2011 (FR) 11 62383

(51) Int. Cl. C10G 53/02; B01J 19/24; C10G 53/04; C10G 55/04; C10G 67/02

(52) U.S. Cl. CPC C10G 53/02; C10G 55/04; C10G 67/02; C10G 53/04; B01J 19/24; B01J 2219/24

(57) ABSTRACT

Method for optimising the production of middle distillate in a refinery, comprising at least one catalytic cracking unit (3) and at least one vacuum distillation unit (2, 4), the optimising operation consisting in:
a) recycling (14) at least part of the cut obtained by fractionation of the effluents from catalytic cracking of an atmospheric and/or vacuum residue, distilling at at least 320° C. also called 320° C.+ cut in the feed of the said vacuum distillation unit (4),
b) distilling the said cut under vacuum into at least two fractions, a fraction distilling between 320° C. and 550° C. called the HCOSV fraction, and a fraction distilling at at least 550° C. called the SSV fraction,
c) sending the HCOSV fraction (18) thereby obtained to at least one of the distillate treatment units,
d) and sending the SSV fraction (13) to the feed of the catalytic cracking unit (3), as such or after intermediate upgrading treatment.

The present invention relates to the field of catalytic cracking (or FCC) of petroleum cuts, more particularly to the field of the refining of these cuts in combination with the vacuum distillation means and other process for upgrading heavy petroleum cuts. The upgrading of heavy cuts means any process such as deasphalting, visbreaking, coking and residue hydroconversion (hydrotreating and/or hydrocracking).

### PRIOR ART

The person skilled in the art knows how to use the catalytic cracking process as a means for preparing upgradable cuts from heavy cuts and, in particular, from vacuum residues (RSV), atmospheric residues (RAT) and vacuum distillates, mainly vacuum gas oils or VGO.

In the problem of optimization considered by the present invention, the objective is to recover even more upgradable distillates from the heavy cuts recovered at the fractionation outlet of a catalytic cracking unit, without an additional prior cracking operation. The distillate thus recovered is treated as a vacuum distillate (DSV). The heavy cuts concerned are mainly cuts distilling from 320° C., that is to say, 320° C.-450° C. fractions commonly called Heavy Cycle Oil (HCO) and slurry fractions distilling at 450° C. or more.

The recycling of the cut issuing from catalytic cracking and distilling above 320° C., sent as such in a mixture with the feeds of the visbreaking, coker, residue hydroconversion and/or deasphalting units, is commonly carried out in a single step.

Furthermore, to optimise the conversion of vacuum and/or atmospheric residues, patent FR2939804 describes the pretreatment thereof by double deasphalting before introducing Deasphalted Oil (DAO) alone in the feed of a catalytic cracking unit. In this document, the objective is to limit the quantities of metals and sulphur, and also to limit the Conradson carbon of the residue entering the FCC unit: the asphaltenes are extracted and the deasphalted oil is recovered, stripped of the lightest distillates, before sending it to the catalytic cracking unit.

In application WO2006/104661, to improve the gasoline and distillate yield, the cuts distilling above 350° C., issuing from the fractionation of a FCC unit, are separated in a separation zone into a stream comprising the saturated compounds and the monocyclic and bicyclic aromatic compounds, on the one hand, and a stream comprising a majority of the aromatic compounds having a number of adjacent rings equal to or greater than 3, on the other hand. Only the stream comprising the saturated compounds and monocyclic and bicyclic aromatic compounds is reintroduced into the feed before entering the reactor of the catalytic cracking unit. The separation into saturated and monocyclic and bicyclic aromatic streams and into a stream comprising a majority of aromatics having at least three adjacent rings is obtained either by solvent extraction of the dimethylsulphoxide, dimethylformamide, n-methylpyrrolidone, phenol and/or furfural type, or by liquid chromatography, or even by membrane separation, in particular by polymer membranes. This configuration is particularly suitable for short contact time FCC processes.

In patent U.S. Pat. No. 3,891,538, it is considered to incorporate a plurality of processes present in the same refinery to optimise the slightest drop of upgradable hydrocarbons. Thus, this document proposes treating an atmospheric residue by combining a RAT desulphurization process associated with a fractionation process, a catalytic cracking process and a coking process. In this combination, the HCO (Heavy Cycle Oil or 370-550° C. cut) leaving the catalytic cracking unit is recycled in the RAT (atmospheric residue) fed to the desulphurization unit, and the slurry is sent to the feed sent to the coking zone of the coker, in a mixture with the cut distilling at over 535° C. issuing from the fractionation of the effluent leaving the desulphurization unit.

In patent U.S. Pat. No. 3,072,560, the objective is to convert the residues to gasoline, the said objective being achieved by combining the catalytic cracking process with other processes such as coking, hydrocracking and reforming, associated with various intermediate fractionations, the combination consisting in recycling the light distillate (or LCO, light cycle oil) issuing from the catalytic cracking to hydrocracking, and the HCO either to catalytic cracking or to any other appropriate use of the refinery.

None of these documents allows for extracting the maximum of distillates still present in the fraction issuing from the fractionation of the effluents of a catalytic cracking unit fed with residues and distilling from 320° C., before recycling all or part of the said fraction in the feed of a catalytic cracker.

### BRIEF DESCRIPTION OF THE INVENTION

The present invention applies equally to FCC units using an upflow reactor (riser) and to units using a downflow reactor (downer) or even to units comprising one or more reactors, regardless of the flow direction (upflow and/or downflow).

The invention is a method for optimising the production of middle distillate in a refinery, comprising at least one catalytic cracking unit with fractionation of the effluents for treating an atmospheric and/or vacuum residue type of feed and at least one vacuum distillation unit, the optimising operation consisting in:
a) sending at least part of the 320° C.+ cut obtained by fractionation of the effluents from the catalytic cracking of the said feed,
b) distilling the said cut, in the said vacuum distillation unit, into at least two fractions, a fraction distilling between 320° C. and 550° C. called the HCO vacuum fraction (or HCOSV fraction), and a fraction distilling at at least 550° C. called the vacuum slurry fraction (or SSV fraction),
c) sending the HCOSV fraction thereby obtained to at least one distillate treatment unit,
d) and sending the SSV fraction to the feed of the catalytic cracking unit and/or to the heavy fuel oil blending and storage units, as such or after intermediate upgrading treatment.

The said vacuum distillation unit may be the vacuum distillation unit used for distilling the atmospheric residues or RAT issuing from the atmospheric distillation of crude oil, available in the refinery, or a unit intended for the vacuum separation of the two SSV and HCOSV fractions from the 320° C.+ cut, the said cut being obtained as such from the fractionation of the effluents of the catalytic cracking unit or in two or three cuts also issuing from the fractionation of the effluents of the catalytic cracking unit, which are remixed.

The HCOSV fraction may be sent alone or in a mixture with at least one vacuum distillate DSV to at least one distillate treatment unit, whereas the SSV fraction may be sent alone or in a mixture with at least one vacuum residue or RSV and/or at least one atmospheric distillation residue or RAT, in the feed of the catalytic cracking unit.

When the 320° C.+ cut is recycled in the feed of the said vacuum distillation unit, the HCOSV fraction (cut distilling between 320° C. and 550° C.) is distilled in a mixture with the vacuum distillate (DSV), the mixture optionally being sent to a hydroconversion unit, while the fraction distilling at at least 550° C. (or SSV fraction) is distilled and recycled in a mixture with the vacuum residue to the catalytic cracking unit, the said mixture being recycled as such as feed or after intermediate upgrading treatment of the said mixture.

Intermediate upgrading treatment of the SSV fraction or of its mixture with the vacuum residue at the outlet of the vacuum distillation unit, means any treatment process converting these residues to upgradable products such as visbreaking, coking and, more preferably, deasphalting in at least one step of separating the asphaltenes from the mixture or even residue hydroconversion.

The present invention further comprises the device associated with implementing the method comprising vacuum distillation and catalytic cracking units, but also units for hydroconverting the HCOSV fractions alone or in a mixture with DSV (vacuum distillate), and units for upgrading the SSV fractions alone or in a mixture with the RSV residues, and the use of the said device for implementing the method according to the invention.

### DETAILED DESCRIPTION OF THE INVENTION

The optimization method of the invention is based on the most appropriate use of existing processes in a refinery for extracting, without modifying them, the maximum of distillates from the heavy 320° C.+ fractions recovered at the outlet of the fractionation of FCC effluents.

This sequence of processes is considered for refineries equipped with atmospheric and vacuum distillation units and with at least one catalytic cracking unit capable of treating RSV and RAT residues.

In the context of the invention, distillate means any hydrocarbon cut having a distillation cut temperature of approximately 300 to 550° C.

The vacuum distillate (DSV) issuing from a vacuum distillation and a cut distilling from 300 to 550° C., is a highly desirable intermediate product because it can be upgraded via numerous conversion units such as, for example, hydrocracking, hydrotreating, FCC (or fluidised bed catalytic cracking). Thus, any product with similar properties having comparable densities, boiling intervals and other properties, can be advantageous and can be treated together with these DSV.

Conventionally, such distillates (DSV) were fed to catalytic cracking units, in particular to fluidised bed catalytic cracking units, for the massive production of high octane gasoline. Faced with developments in the market for gasoline and diesel fuels, DSV are preferably sent to hydroconversion units such as hydrocracking, hydrotreating, hydrometallization, deep hydrodesulphurization and/or hydrodearomatization units. The objective of this hydroconversion is to reduce the sulphur, metal and nitrogen contents of the fuel base stocks to meet the anticipated specifications for base stocks used for preparing diesel fuels, in particular having a residual sulphur content lower than 10 ppm, and a very high cetane number. Another objective is to prepare home-heating oils with these fuel base stocks, or low sulphur heavy fuel bunker oils (sulphur content lower than 1000 ppm by weight).

The 320° C.+ cut recovered from the fractionation of the effluents of the catalytic cracking unit potentially contains a cut distilling between 320° C. and 550° C. corresponding to a distillate cut answering to the definition of DSV, and whose properties are close to those of DSV.

According to the invention, by recycling the 320° C.+ cut to a vacuum distillation unit to separate it into two fractions, a HCOSV fraction is obtained having a 320° C. to 550° C. distillation cut which can be recycled to a distillate treatment unit, such as a hydroconversion unit, like the DSV and atmospheric distillates (DAT), and a SSV fraction having a distillation cut equal to or higher than 550° C. which can be recycled to other intermediate upgrading treatment units, for example conversion units such as coker, visbreaking, residue hydroconversion and deasphalting units. The operating conditions for these conversion units are the classical conditions usually employed by the man skilled in the art to treat a distillation cut equal to or higher than 550° C.

In particular, all or part of the SSV fraction, alone or in mixture with at least one RAT and/or RSV residue, may be traited in an intermediate upgrading treatment unit before being sent back in the feed of the catalytic cracking unit and/or before being sent in the units for heavy fuel oil blending and storage. In particular, a gas oil cut extracted as such from said intermediate upgrading treatment unit can be recovered and this gas oil cut can be sent back in the feed of the catalytic cracking unit and/or in the units for heavy fuel oil blending and storage.

The unit(s) for treating the HCOSV fractions, that is to say the distillate treatment units, are selected, for example, from hydroconversion, hydrotreating units for desulphurization, demetallization and/or hydrodearomatization, and/or hydrocracking.

The operating conditions of these distillate treatment units are the classical conditions usually employed by the man skilled in the art to treat a 320° C. to 550° C. distillation cut.

In the absence of intermediate upgrading treatment units, such as conversion units, the SSV fraction can be sent to the heavy fuel oil blending and storage units and/or can be sent in the feed of the catalytic cracking unit.

The present invention, by combining the catalytic cracking unit and the separation into two distinct fractions, in a unit for the vacuum distillation of the 320° C.+ cut, serves advantageously to use the catalytic cracking unit as a means for directly and indirectly producing distillates from low grade products, or products for which production is to be minimised, such as, for example, gasolines and naphthas, without directly treating the 320° C.+ cut by visbreaking, coking, residue hydroconversion or other methods. Furthermore, only the most favourable compounds are recycled to the distillate upgrading units with a better capacity for conversion to noble products than by retreating these distillates via the heavy cut treatment units previously mentioned.

Another advantage of the present invention is that it applies mainly to a catalytic cracking unit operating in a maxi-distillate or low conversion mode. It may also apply when the cracking unit operates at higher conversion, for example in maxi-gasoline mode and/or in the production of light olefins, propylene, butene and others.

The man skilled in the art knows how to adapt the operating conditions of the catalytic cracking unit to operate this unit in low conversion or high conversion modes.

Usually, in low conversion mode, the operating conditions are for example a reaction temperature comprised between 480° C. and 510° C., the intrinsic activity of the catalyst being characterized by a MAT comprised between 65 and 70. The MAT (acronym for Micro Activity Test) is a test for measuring activity according to norm ASTM D-3907. The result of this test is a relative conversion activity of a catalyst for a standard feed.

Usually, in high conversion mode, the operating conditions are for example a reaction temperature comprised between 510° C. and 540° C., the intrinsic activity of the catalyst being characterized by a MAT comprised between 70 and 75.

When the separation into two fractions is carried out in the same vacuum distillation unit as the one used for the vacuum distillation of the atmospheric residues or RAT, the SSV fraction can follow the same treatment as the vacuum residue recovered at the column outlet, preferably in a mixture with the RSV, and the HCOSV fraction can follow the same treatment as the DSV produced, preferably in a mixture therewith.

In a mixture with the vacuum residue RSV, independently of the crude oil from which it is extracted, the SSV fraction issuing from the catalytic cracking effluents is not always treated directly in a catalytic cracking unit when its hydrogen content is too low, lower than 11.5% by weight. In this case, all or part of this fraction can be upgraded by an intermediate upgrading or conversion treatment such as, for example, by coking, and the coker gas oil thus recovered can be recycled advantageously in the feed of the catalytic cracking unit, optionally after hydrotreating. Usual operating conditions of the catalytic cracking are for example a reaction temperature comprised between 480° C. and 510° C., a pressure between 1 and 3 barg and a recycle of 5 to 20% by weight.

In a second embodiment, all or part of the SSV fraction, taken alone or in a mixture with the RSV, can also be recycled in the feed of a visbreaking unit. The visbroken gas oil cut recovered at the outlet of the unit could advantageously be part of the composition of the fuel oils of the distillate type, in the same way as the lighter or gas oil distillates having a cut distilling from 150° C. to 370° C.

The operating conditions of the visbreaking unit are the classical conditions usually employed by the man skilled in the art to treat a distillation cut equal to or higher than 550° C., alone or in mixture with a vacuum residue (RSV). For example, operating conditions that can be used are a reaction temperature between 420 and 450° C. for a pressure between 8 and 12 barg and a duration from 10 to 30 min.

A third embodiment is that all or part of the SSV fraction, taken alone or in a mixture with RSV, can be sent to a residue hydroconversion unit, before being sent back in the feed of the catalytic cracking unit and/or to the heavy fuel oil blending and storage units. The operating conditions of such a hydroconversion unit are the classical conditions usually employed by the man skilled in the art to treat residues. For example, operating conditions that can be used are a reaction temperature between 415 and 460° C. for a total pressure between 120 and 180 barg and a VVH between 0.2 and 0.8 h⁻¹.

A fourth embodiment is that all or part of the SSV fraction, alone or in a mixture with RSV, can be sent to a solvent extraction unit, for example a deasphalting unit, to be separated therein into two phases, a first phase comprising the saturated compounds and hardly condensed aromatic compounds, recycled in the feed of the catalytic cracking unit, and a second phase comprising the highly condensed aromatic compounds, sent to the heavy fuel blending and storage units.

Hardly condensed aromatic compounds are meant to be compounds comprising at most two adjacent aromatic rings, as for example: naphthalene, azulene, indene and their derivatives.

Highly condensed aromatic compounds are meant to be compounds comprising at least three adjacent aromatic rings, as for example: anthracene, phenanthrene, fluorine, phenalene, acenaphthylene, indacene, and their derivatives.

The aim here is to separate the highly condensed aromatic compounds containing very high metal contents. The solvent is therefore selected to remove most of the highly condensed aromatic compounds, for example comprising at least three adjacent aromatic rings, from the fraction containing saturated compounds and aromatic compounds having a maximum of two aromatic rings. In the case of a deasphalting unit, the deasphalted portion of the mixture entering the deasphalting unit can advantageously be recycled in the feed of the catalytic cracking unit, the asphaltenic portion (or deasphalting pitch) recovered is recycled to the units for heavy fuel oil blending and storage, asphalt production, coking and/or production of granules for combustion in boilers.

To extract the highly condensed aromatic compounds, or even to deasphalt heavy hydrocarbon feedstocks, it is common practice to use hydrocarbon solvents capable of isolating the polycondensed or even asphaltenic aromatic compounds, from the products recyclable to a catalytic cracking unit, comprising saturated compounds and polycondensed aromatics having a maximum of two adjacent aromatic rings. These solvents are selected from the hydrocarbon cuts having 3 to 9 carbon atoms, furfural, alkylketones, or any other polar compound having a suitable selectivity. Preferably, in the context of the present invention, the extraction comprises a single step with extraction using a C3 and/or C4 paraffinic solvent. On the one hand, a mixture of saturated compounds is collected in a mixture with maltenes, which is introduced as a feed in the catalytic cracking unit, and, on the other hand, an asphaltenic mixture.

The man skilled in the art knows how to choose the deasphalting conditions in function of the nature of the solvent used. For example, for a C3 paraffinic solvent, a deasphalting temperature between 55 and 90° C. may be chosen for a pressure between 30 and 40 barg, with a solvent ratio of 600% to 1000% in volume with respect to the feed to treat. For a C5 paraffinic solvent, a deasphalting temperature between 165 and 210° C. may be chosen for a pressure between 30 and 40 barg, with a solvent ratio of 300% to 600% in volume.

The advantage of proceeding by deasphalting type extraction is to produce an extract of the mixture of the SSV fraction with the vacuum residue, whose hydrogen content is increased, thereby increasing the conversion potential of the method, whereof the CCR value is reduced, lowering the production of coke in the catalytic cracking unit. Furthermore, the nickel and vanadium metal content is very low or even nil, thereby limiting the deactivation of the catalytic cracking catalysts.

In a preferable embodiment, to increase the production of distillates for diesel fuels, the catalytic cracking unit is operated at low conversion, favouring the production of cuts having a boiling point above 150° C.

The device according to the invention advantageously comprises at least one catalytic cracking unit equipped with effluent fractionation, and at least one vacuum distillation unit, a pipe joining the catalytic cracking fractionation unit to one of the vacuum distillation units, the said pipe allowing the return of a 320° C.+ cut in the feed of the said vacuum distillation unit. This vacuum distillation unit advantageously comprises at least two distinct discharge pipes, one for the HCOSV fraction and the other for the SSV fraction.

The device according to the invention can comprise:
at least one distillate treatment unit and one or several first discharge pipes joining said distillate treatment unit to the vacuum distillation unit connected to the previously mentioned pipe (in other words the vacuum distillation unit receiving the 320° C.+ cut). This or these first discharge pipes are arranged to carry a HCOSV fraction. It may be one of the two distinct discharge pipes of the vacuum distillation unit previously mentioned.
One or several heavy fuel oil blending and storage units, and one or several second discharge pipes arranged to carry a SSV fraction from the vacuum distillation unit receiving the 320° C.+ cut to said catalytic cracking and/or to the heavy fuel oil blending and storage unit(s). Such second discharge pipe can be the other of the two distinct discharge pipes of the vacuum distillation unit previously mentioned.

In a preferred embodiment of the invention, the distillation unit is a vacuum distillation unit used for distilling atmospheric residue (RAT), one discharge pipe allowing the joint discharge of the HCOSV fraction and the DSV, and the other discharge pipe allowing the joint discharge of the residue and the SSV fraction.

In all cases, the said discharge pipe of the SSV fraction, alone or in a mixture with the residue, can terminate in an intermediate upgrading treatment unit, for example in a visbreaking unit, or in a coker unit or a deasphalting unit or in a residue hydroconversion unit. At least one pipe can be provided for connecting said intermediate upgrading treatment unit to one or several heavy fuel oil blending and storage units and/or to the catalytic cracking unit.

At least one discharge pipe for the SSV fraction, alone or in mixture with the residue, can also terminate in one or several heavy fuel oil blending and storage units and/or to the catalytic cracking unit.

The invention is now described with reference to the appended non-limiting drawings, in which:

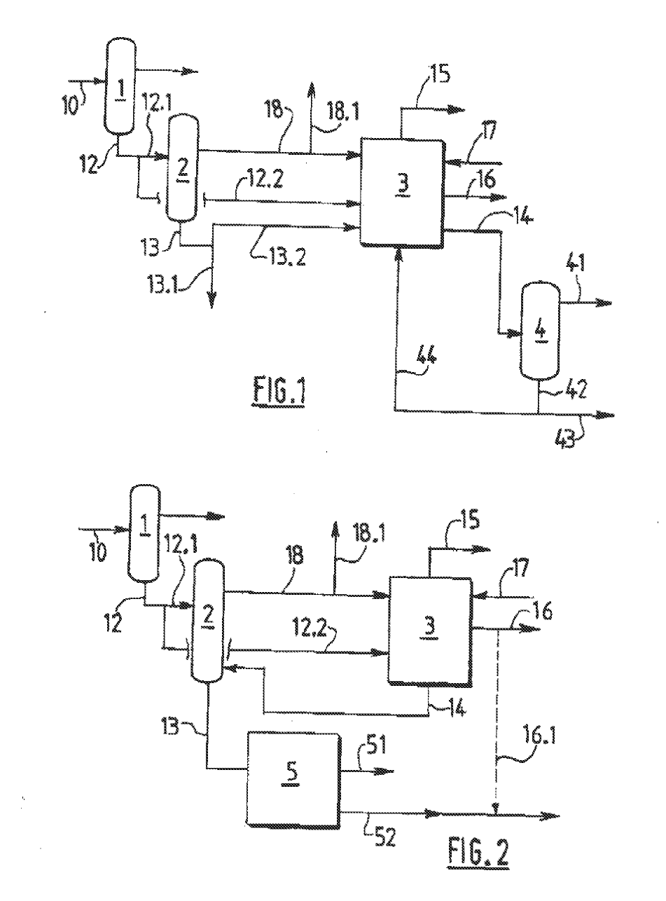

FIG. 1 is a representation of the device for implementing the optimization method according to the invention without associated treatment units.

FIG. 2 is a representation of the device when the method comprises a visbreaking step.

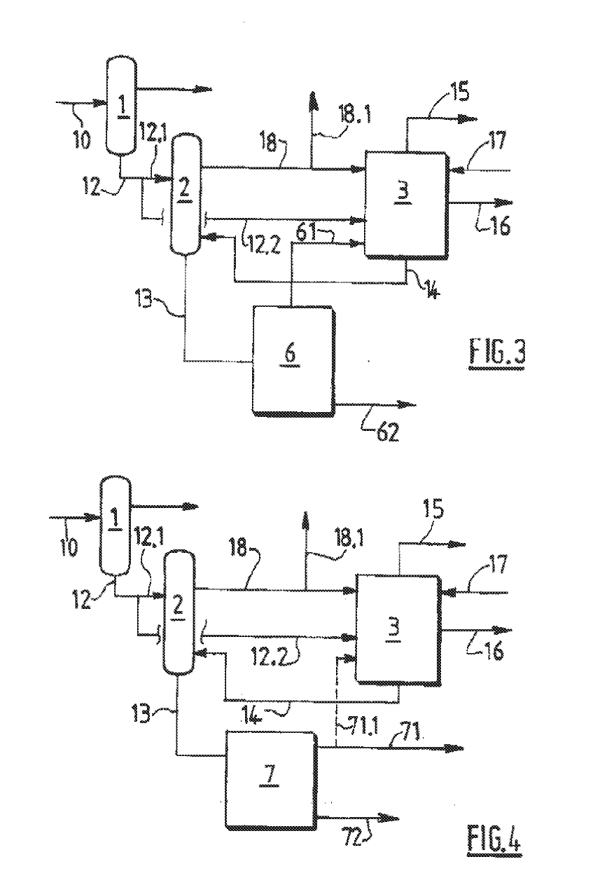

FIG. 3 is a representation of the device when the method comprises a deasphalting step.

FIG. 4 is a representation of the device when the method comprises a coking step.

FIG. 1 comprises the simplest optimization flowchart of the inventive method. It comprises four main units which are atmospheric distillation (1) fed with crude oil via the pipe (10), vacuum distillation (2) of the RAT or atmospheric residue arriving via the pipe (12 versus 12.1), catalytic cracking (3) and a second vacuum distillation (4) for separating the 350° C.+ cut arriving via the pipe (14) in two fractions, the distillate fraction (41) which is returned in the same way as the distillate fraction (350-550° C.) via the pipe (18 versus 18.1) to a hydrocracking unit, and the slurry fraction (42) which is partly recycled via the pipe (44) to the feed of catalytic cracking (3) which may further comprise RAT arriving via the pipe (12.2), vacuum distillate (DSV) via the pipe (18) and/or even vacuum residue via the pipe (13 versus 13.2), a portion thereof being returned via the pipe (13.1) to fuel oil blending and storage. The other portion of the slurry is returned via the pipe (43) to fuel oil blending and storage.

In comparison with the effluents entering and leaving the catalytic cracking unit, the pipes (15) and (16) correspond respectively to the discharge pipes for gasoline and light distillate or Light Cycle Oil (LCO), and the pipe (17) corresponds to an injection of naphtha, light gasoline or Light Cracked Naphtha (LCN) so as to reduce their production and hence their use in in-line blends for producing gasoline base stocks. The naphthas may be catalytic cracking, hydroconversion, atmospheric distillation, coker and/or visbreaking naphthas.

FIG. 2 shows a representation of the method of the invention identical to FIG. 1, in which vacuum distillation (4) is replaced by a visbreaker (5). At the outlet of catalytic cracking (3), the 350° C.+ cut arriving via the pipe (14) is sent to vacuum distillation (2) either in the feed pipe (12.1), or directly in the vessel at the level of the lowest trays. The RSV recovered in the distillation bottom (2) comprising the “slurry fraction” portion of the 350° C.+ cut is returned via the pipe (13) to a visbreaking unit (5), the light compounds and the visbroken gas oils and naphthas are recovered via the pipe (51), the visbroken residues via the pipe (52) are sent to fuel oil blending and storage, optionally in a mixture with LCO recycled from catalytic cracking (3) via the line (16.1).

The description of FIG. 3 is identical to the description of FIG. 2 except that a deasphalting unit (6) replaces the visbreaking unit (5) on the outlet pipe (13) of the RSV comprising the “slurry fraction” portion of the 350° C.+ cut, from vacuum distillation (2). This deasphalting takes place in a single step by extraction using a paraffinic solvent, comprising 3 to 4 carbon atoms per chain, which serves to extract the saturated compounds and the aromatic compounds comprising a maximum of two adjacent aromatic rings corresponding to the resins up to the maltenes which are returned via the pipe (61) to the catalytic cracking unit (3). The asphaltenic compounds or highly condensed aromatic compounds comprising three adjacent aromatic rings or more are returned via the pipe (62) to pitch storage, and/or to the fuel oil blending and storage installations.

The description of FIG. 4 is identical to the description of FIG. 2 except that a coker unit (7) replaces the visbreaking unit (5) on the outlet pipe (13) of the RSV comprising the “slurry fraction” portion of the 350° C.+ cut, from vacuum distillation (2). The coker unit (7) produces heavy coker gas oil removed via the pipe (71) and coke discharged via the pipe (72). The heavy coker gas oil can optionally be returned at least partly as feed to the catalytic cracking unit (3) via the line (71.1).

Examples are given below to illustrate the invention, but cannot be interpreted as limitations of the invention.

### Example

The present example shows the advantages of the present invention by demonstrating the possibility of recovering HCOSV and SSV as a function of the conversion level obtained in the catalytic cracking unit.

The results were obtained on a circulating bed pilot unit equipped with a reaction zone and a regeneration zone using a feed composed of a mixture of vacuum-distilled gas oil or VGO and RAT and with a conventional catalytic cracking catalyst.

Three cases are presented for an increasing conversion level set in the catalytic cracking unit. In cases 1 and 2, operation takes place at low conversion, that is to say, at 54.3% and 65.6% by weight of yield respectively for the cracking reaction: they correspond to operating modes called distillate or maxi-distillate modes of the catalytic cracking unit, whereas case 3 rather characterises a conventional operating mode called gasoline or maxi-gasoline mode with a yield of 74.4% by weight.

TABLE 1

| | | Case 1 | Case 2 | Case 3 |
|---|---|---|---|---|
| Operating | Catalyst/fresh feed | 8.4 | 11.2 | 13.2 |
| conditions | ratio (wt/wt) | | | |
| | Reaction T (° C.) in | 484.8 | 509.1 | 522.2 |
| | FCC | | | |
| Standard conversion (wt %) | | 54.3 | 65.6 | 74.4 |
| Yield per cut | Fuel gas | 1.36 | 2.46 | 2.99 |
| after cracking in | LPG | 6.8 | 11.3 | 13.5 |
| FCC (wt %) | Gasoline (PI-220° C.) | 40.2 | 46.1 | 51.4 |
| | LCO (220-350° C.) | 23.7 | 19.8 | 17.1 |
| | Slurry (350+° C.) | 21.9 | 14.6 | 8.5 |
| | Coke | 6.0 | 5.8 | 6.5 |
| Recovery as | 350-450/450+ ° C. | 16.6/5.5 | 10.6/4.0 | 5.3/3.1 |
| HCOSV/SSV of | 350-500/500+ ° C. | 20.6/1.3 | 13.7/0.9 | 7.8/0.6 |
| slurry as a | 350-550/550+ ° C. | 21.6/0.3 | 14.3/0.3 | 8.2/0.3 |
| function of | | | | |
| vacuum | | | | |
| distillation cut | | | | |
| point (wt %) | | | | |

The production of slurry (350+ cut) decreases from 21.9% to 8.5% at the same time as the conversion level. In the absence of vacuum distillation, this 350+ cut is generally sent to the heavy fuel oil pool.

When this cut is recycled as a vacuum distillation feed (see yields in the last lines of the table), a significant share of the 350-550° C. or HCOSV cut can be recovered, and can be upgraded to distillate like the distillate (DSV), and the SSV recovered is always sent to the heavy fuel oil pool.

In the specific case in which the SSV is treated in a deasphalting unit, two cuts are obtained. A first cut has properties similar to HCOSV (density, aromatic compounds content): it is called deasphalted distillate and accounts for 50% by weight of the initial SSV with a Conradson Carbon (CCR) lower than 5% by weight. The second cut, called deasphalting pitch, has a CCR of about 20% by weight and can be upgraded as heavy fuel oil. Based on case 1, since the production of SSV accounts for 0.3% by weight of the feed of the catalytic cracking unit and production, the deasphalted distillate therefore accounts for 0.15% by weight of this feed. In consequence, the incorporation of an intermediate upgrading treatment such as a deasphalting unit allows an additional gain of 0.15% by weight of distillate which can be combined with the production of HCOSV.

1. Method for optimising the production of middle distillate in a refinery, comprising at least one catalytic cracking unit with fractionation of the effluents for treating an atmospheric and/or vacuum residue type of feed and at least one vacuum distillation unit, the optimising comprising:
a) sending at least part of a cut obtained by fractionation of the effluents from the catalytic cracking of the said feed, distilling at at least 320° C. also called 320° C.+ cut in the feed of the said vacuum distillation unit,
b) distilling the said cut under vacuum into at least two fractions, a fraction distilling between 320° C. and 550° C. called the HCOSV fraction, and a fraction distilling at at least 550° C. called the SSV fraction,
c) sending the HCOSV fraction thereby obtained to at least one distillate treatment unit, and
d) sending the SSV fraction, as such or after intermediate upgrading treatment, to the feed of the catalytic cracking unit and/or to heavy fuel oil blending and storage units.

2. Method according to claim 1, characterised in that the said vacuum distillation unit is the vacuum distillation unit used for distilling the atmospheric residues or RAT issuing from the atmospheric distillation of crude oil or a unit intended for the vacuum separation of the two SSV and HCOSV fractions from the 320° C.+ cut.

3. Method according to claim 1, characterised in that the HCOSV fraction is sent alone or in a mixture with at least one vacuum distillate DSV to at least one distillate treatment unit.

4. Method according to claim 1, characterised in that in step (d), the SSV fraction is sent, alone or in a mixture with at least one vacuum residue or RSV and/or at least one atmospheric distillation residue or RAT, in the feed of the catalytic cracking unit.

5. Method according to claim 1, characterised in that the unit(s) for treating the HCOSV fractions are selected from hydroconversion, hydrotreating units for desulphurization, demetallization and/or hydrodearomatization, and/or hydrocracking.

6. Method according to claim 4, characterised in that the SSV fraction is introduced alone or in a mixture with at least one RAT and/or RSV residue in the feed of the catalytic cracking unit and/or in the heavy fuel oil blending and storage units after treatment in a visbreaking unit.

7. Method according to claim 4, characterised in that the SSV fraction is introduced alone or in a mixture with at least one RAT and/or RSV residue in the feed of the catalytic cracking unit and/or in the heavy fuel oil blending and storage units after treatment in a coker unit.

8. Method according to claim 4, characterised in that the SSV fraction is introduced alone or in a mixture with at least one RSV in the feed of the catalytic cracking unit and/or in the heavy fuel oil blending and storage units after treatment in a residue hydroconversion unit.

9. Method according to claim 4, characterised in that the SSV fraction is introduced alone or in a mixture with at least one RAT and/or RSV residue in the feed of the catalytic cracking unit and/or in the heavy fuel oil blending and storage units after treatment in a solvent extraction unit to be separated therein into two phases, a first phase comprising the saturated compounds and hardly condensed aromatic compounds, recycled in the feed of the catalytic cracking unit, and a second phase comprising the highly condensed aromatic compounds, sent to the heavy fuel blending and storage units.

10. Method according to claim 9, characterised in that the solvent extraction unit using a hydrocarbon solvent is a deasphalting unit, the first phase comprising a deasphalted oil or DAO recycled in the feed of the catalytic cracking unit, and the second phase comprising the asphaltenic compounds or deasphalting pitch, these compounds in a mixture with other hydrocarbons being sent to the units for heavy fuel oil storage, asphalt production, coking and/or the production of granules for combustion in the refinery boilers.

11. Method according to claim 1, characterised in that the catalytic cracking unit is operated at low conversion.

12. Device for implementing the method according to claim 1, comprising at least one catalytic cracking unit (3) equipped with an effluent fractionation unit, and at least one vacuum distillation unit (2, 4), a pipe (14) joining the catalytic cracking fractionation unit to one of the vacuum distillation units (2, 4), the said pipe (14) allowing the return of the 320° C.+ cut in the feed of the said vacuum distillation unit (2) or (4), at least one distillate treatment unit and at least one discharge pipe (18) joining said distillate treatment unit to the vacuum distillation units (2, 4) connected to said pipe (14), said at least one discharge pipe (18) being arranged to carry a HCSV fraction, one or several heavy fuel oil blending and storage units and at least one other discharge pipe (13, 42) arranged to carry a SSV fraction from the vacuum distillation units (2, 4) connected to said pipe (14) to said catalytic cracking unit (3) and/or to said heavy fuel oil blending and storage unit(s).

13. Device according to claim 12, characterised in that the vacuum distillation unit (2) comprises at least two distinct discharge pipes, one for the HCOSV fraction (18) and the other for the SSV fraction (13, 42).

14. Device according to claim 12, characterised in that the distillation unit is an atmospheric residue vacuum distillation unit (2), the pipe (18) allowing the joint discharge of the HCOSV fraction and the DSV, and the pipe (13, 42) allowing the joint discharge of the residue and the SSV fraction.

15. Device according to claim 12, characterised in that the discharge pipe (13) of the SSV fraction alone or in a mixture with the residue terminates in a visbreaking unit (5).

16. Device according to claim 12, characterised in that the discharge pipe (13) of the SSV fraction alone or in a mixture with the residue terminates in a coker unit (7).

17. Device according to claim 12, characterised in that the discharge pipe (13) of the SSV fraction alone or in a mixture with the residue terminates in a deasphalting unit (6), comprising a pipe (61) for discharging the deasphalted oil terminating in the feed of the catalytic cracking unit and a pipe (62) for the deasphalting pitch terminating in the fuel blending installations.

18. Device according to claim 12, characterised in that the discharge pipe of the SSV fraction alone or in a mixture with the residue terminates in a residue hydroconversion unit.
